(19) United States
(12) Patent Application Publication
(10) Pub. No.: US 2024/0271668 A1
(43) Pub. Date: Aug. 15, 2024

(54) ELECTROADHESIVE CLUTCH FOR UNIVERSAL LOAD DIRECTIONS TRANSMISSION

(71) Applicant: ESTAT Actuation, Inc., Pittsburgh, PA (US)

(72) Inventors: Stuart B. Diller, Pittsburgh, PA (US); Kirby A. Witte, Pittsburgh, PA (US); Carmel Majidi, Pittsburgh, PA (US); Brock Zekany, Pittsburgh, PA (US)

(73) Assignee: ESTAT Actuation, Inc., Pittsburgh, PA (US)

(21) Appl. No.: 18/290,510

(22) PCT Filed: May 16, 2022
(86) PCT No.: PCT/US2022/029495

§ 371 Date: Nov. 14, 2023

Related U.S. Application Data
(60) Provisional application No. 63/188,874, filed on May 14, 2021.

(51) Int. Cl. F16D 28/00

(52) U.S. Cl. CPC F16D 28/00

(57) ABSTRACT

An electroadhesive clutch that establishes a quick, electrically-controllable connection of two components capable of transmitting complex loading across the connection. The quick connection is comprised of at least two electrodes separated by a dielectric material, where one of the electrodes is flexible. The dielectric material may coat or otherwise be attached to one or several electrodes or, alternatively, be placed between opposing electrodes.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates generally to an electroadhesive clutch, and more particularly to an electroadhesive clutch with at least one plate that quickly and electrically-controllably engages an opposing plate, multiple plates, or a conductive surface for transmitting any combination of normal, shear, and torsional loads.

Existing methods for connecting and disconnecting surfaces or opening and closing devices are limited by practical design constraints. Conventional mechanical latches require mechanisms like those found in doors, which are large, heavy, and protrude from surfaces, and are prone to jamming or breaking. Suction-based devices do not perform well in low-pressure environments, and require either a mechanical mechanism to activate or a bulky valve with a compressor or other vacuum source. Suction-based devices also struggle to connect to substrates with holes. Electromagnets can generate large forces, but typically only work when interacting with ferrous materials, and electromagnets have high weight and power consumption, and can heat up substantially during operation.

Electroadhesive clutches, which operate using static electric charges to create adhesion, use electrically conductive clutch plates that are separated by a dielectric material. When a voltage is applied across opposing clutch plates, where the plates are acting as electrodes, an electrostatic charge develops and creates an attractive state and causing the plates to adhere. With the plates adhered to each other, a force can be transmitted from one plate to the other. Electroadhesive clutches can be created in various shapes, including rotary, stacked rotary, and linear, among others. While existing electroadhesive clutches demonstrate the ability to transmit shear forces, they are typically susceptible to peel while transmitting normal loads and struggle to resist moment loading. Additionally, electroadhesive clutches designed to selectively transmit normal forces between parallel surfaces have typically relied on planar comb electrode designs. These combs can be challenging and expensive to produce, often rely on high voltages above 1,000 volts to activate, and may achieve lower on-state force transmission per unit area than desired, limiting the usefulness of the device. Some current electroadhesive clutches also rely on complex, large, and/or failure prone electrical connections. It would therefore be advantageous to develop a simpler low-voltage electroadhesive clutch that overcomes these limitations to allow transmission of more complex loading including not only shear forces but also normal forces, and moments. Such a clutch could be used to quickly establish and release connections between two components and has applications across many fields.

### BRIEF SUMMARY

Disclosed herein is an electroadhesive clutch that establishes a quick, electrically-controllable connection of two components capable of transmitting complex loading across the connection. The quick connection comprises at least two electrodes separated by a dielectric material. The dielectric material may coat or otherwise be attached to one or both electrodes. The dielectric material can also be placed between the electrodes without attachment to either. The dielectric layer can be polymer or ceramic based, which may be attached to the electrode(s) with connective hardware or glue, or applied via anodizing, sputtering, chemical vapor deposition, solvent casting, painting, roll-to-roll coating, UV curing, and other known methods. The dielectric prevents the two electrodes from contacting one another.

At least one of the electrodes is flexible and can be connected to a rigid connector in the middle and flexible around its perimeter, or connected to a rigid substrate with a soft gap-filling material or adhesive. One of the electrodes may be completely rigid. The electrode may be continuous across its entire surface, or patterned in a way that intersperces multiple electrodes on a single surface. The loading applied to the flexible electrode can be applied near its center, which helps prevent peel from being initiated at the flexible edges. Applying the load at the center allows for creation of a vacuum between the electrodes when they are pulled apart which helps further resist peeling. Disclosed herein is also a method of using three or more electrodes to reduce the number, size, or cost of permanent and/or temporary electrical connections in linear, rotary, universal, and other electroadhesive clutch designs. An electrical configuration that uses three or more electrically separate electrodes can enable the entire clutch to function even when some of the electrodes do not have a direct electrical connection to the power supply, resulting in a reduction in the total number of electrical connections and/or eliminating the need for some slip rings, brushes, pins, and other types of connections.

### BRIEF DESCRIPTION OF THE SEVERAL VIEWS OF THE DRAWINGS

FIG. 1 depicts the basic principle of operation of an electroadhesive clutch.

FIG. 2 depicts a universal-loading electroadhesive clutch, according to one embodiment.

FIGS. 3A-3C depict the operation states and a possible loading scenario of a universal-loading electroadhesive clutch.

FIG. 4 depicts a flexible electrode with spatially-varying stiffness.

FIGS. 5A-5B depict one construction of a universal-loading electroadhesive clutch with utilizing one flexible and one rigid electrode.

FIGS. 6A-6B depict one construction of a universal-loading electroadhesive clutch in which one electrode has a rigid backing with conformable gap filling material, and the other electrode is rigid and has surface roughness or irregularities.

FIGS. 7A-7B depict one construction of a universal-loading electroadhesive clutch employing rails to further prevent peel from occurring at the edge.

FIGS. 8A-8B depict one construction of a universal-loading electroadhesive clutch employing two flexible electrodes.

FIGS. 9A-9B depict one construction of universal loading electroadhesive clutch for gripping round or cylindrical surfaces.

FIGS. 10A-10C depict one construction of a universal-loading clutch which uses multiple smaller electrodes to conform to convex, concave, or other non-flat surfaces.

FIG. 11A depicts an electrical configuration where the two electrodes are each electrically connected to a single voltage source. FIG. 11B depicts an electrical configuration where one or more electrodes can be electrically floating and do not require an explicit connection to the voltage source.

FIGS. 12A-12C depict a universal electroadhesive clutch manipulator in which electrical connection to a conductive object is established using a probe routed through a window in the electrode.

FIGS. 13A-13C depict a universal electroadhesive clutch manipulator in which the flexible clutch plate is split into two electrodes and no explicit electrical connection to a manipulated object is needed.

FIG. 14 depicts a number of potential electrode split electrode patterns for an electroadhesive clutch manipulator.

FIG. 15 depicts an electroadhesive universal loading clutch in which a magnet is used to establish alignment.

FIG. 16 depicts an insulating lip applied to prevent shorting at cut edges of coated electrodes.

FIGS. 17A-17C depict an embodiment in which the flexible electrode has convex curvature at the clutch interface.

FIG. 18 depicts an embodiment in which a secondary electrode aids release of the electroadhesive clutch.

FIG. 19 depicts an embodiment in which an electroadhesive clutch controls air flow to the interface between the primary clutch plate and the conductive object.

FIG. 20 depicts an embodiment in which an electroadhesive clutch is used to manipulate a lid that is challenging to grasp otherwise.

FIG. 21 depicts a split-electrode electroadhesive manipulator for handling thin, flexible or conformable objects.

FIG. 22 depicts an exploded view of an electroadhesive manipulator with a selectively adhered flexible electrode for handling conductive materials that are generally flat.

FIG. 23 depicts an embodiment of an electroadhesive clutch connector or manipulator with a sensor incorporated for detecting substrate proximity to inform clutch control.

FIG. 24 depicts a number of potential configurations for universal electroadhesive clutches.

FIGS. 25A-25B depict multiple parallel sets of three electrodes, where one of the electrodes in each set does not require an explicit electrical connection to the voltage supply.

FIGS. 26A-26B depict a set of five electrodes, where three of the electrodes do not require an explicit electrical connection to the voltage supply.

### DETAILED DESCRIPTION

The basic operation of an electrostatic clutch 100 involves at least two electrodes 101 separated by a dielectric material 102. Positive and negative charges accumulate on the electrodes 101 when a voltage is applied across them, resulting in an attractive electroadhesive force as shown in FIG. 1. The dielectric material 102 prevents equalization of the positive and negative charges present on opposing electrodes 101. A controller 103 can be used to adjust the voltage between opposing electrodes 101 which modulates the electroadhesive force produced. The clutch 100 can be disengaged when the voltage difference between the electrodes 101 is removed. This can be achieved by discharging both electrodes 101 to ground, applying an equal voltage to both electrodes 101, or by shorting oppositely charged electrodes 101 to one another.

The following figures show various configurations of the electrostatic clutch 100, where at least one of the electrodes (or clutch plates) 101 is flexible and opposing electrodes 101 are separated by a dielectric material 102. Throughout this disclosure, ‘opposing’ clutch plates or electrodes 101 refers to a structure having electrodes 101 carrying opposite charges, which can be positioned adjacent, parallel, circumferential, or interspersed with each other. As the following figures demonstrate, the flexibility in configuration of the electrodes 101 enables the electrostatic clutch 100 to be used in a wide variety of applications

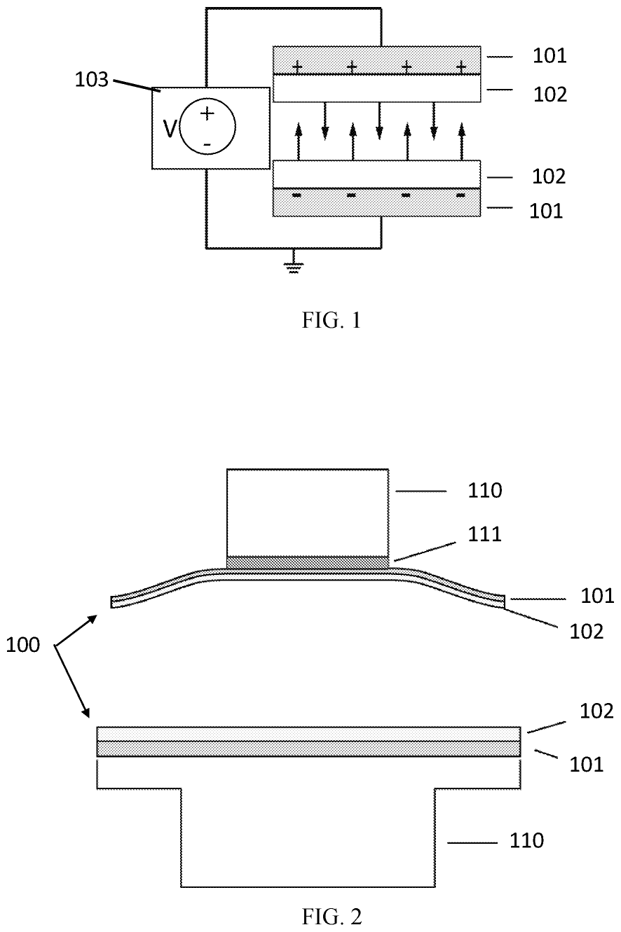

FIG. 2 shows one embodiment of an electroadhesive clutch 100 with the ability to transmit normal, shear and moment loads when engaged by applying load to the center of the flexible electrode 101. As shown in FIG. 2, there are two sides to the clutch 100 which comprises a rigid electrode 101 and a flexible electrode 101. In the example embodiment shown in FIG. 2, each side of the clutch 100 includes an electrode 101 coated with a thin dielectric material 102. The dielectric material 102 may be applied to both sides of the clutch 100 as shown in FIGS. 1-2, or to only one of the electrodes 101. Alternatively, the dielectric material 102 can be placed between opposing electrodes 101 without being applied to either. For example, the dielectric material 102 may comprise a sheet or film that is placed between the two electrodes 101. The flexible side of the clutch 100 includes a small rigid element 110, such as rope attachment, at the center of the electrode 101 to allow for mechanical attachment to other components. With the rigid element 110 located in the middle of the flexible electrode 101 and not at its perimeter, peeling at the clutch interface can be reduced. Although, there may be applications where the rigid element 110 expands beyond the center, is placed near the perimeter, or is attached to other areas of the flexible electrode 101.

Adhesion can be enhanced by the inclusion of an optional low-stiffness, gap-filling material 111 between the rigid element 110 and the flexible electrode 101. The gap-filling material 111, such as a soft adhesive, allows one or more of the electrodes 101 to conform to the other, thus decreasing the space between them and increasing the capacitance across the electrodes 101, which improves holding force. This conforming feature of the electrode 101 backed with gap-filling material 111 enables higher true surface contact between the dielectric-coated electrodes 101, which results in greater adhesion than would be achieved between two rigid surfaces. This is because the ability to conform allows the flexible electrode 101 to physically deform to overcome surface irregularities such as waviness or roughness on the opposing electrode surface. The gap-filling material 111 also distributes loads across the surface of the flexible electrode 101 and accommodates some relative angular deflection between the rigid connector 110 and a rigid substrate 112 without requiring the electrodes 101 to detach. The gap-filling material 111 is optional as it may increase holding strength, but also may decrease accuracy in placement if the clutch is to be used in precision applications. The gap-filling material 111 may be applied selectively in a pattern or in a single continuous area. The gap-filling material 111 may be composed of rubber, silicone, acrylic adhesive, cast polymer, or other relatively soft materials.

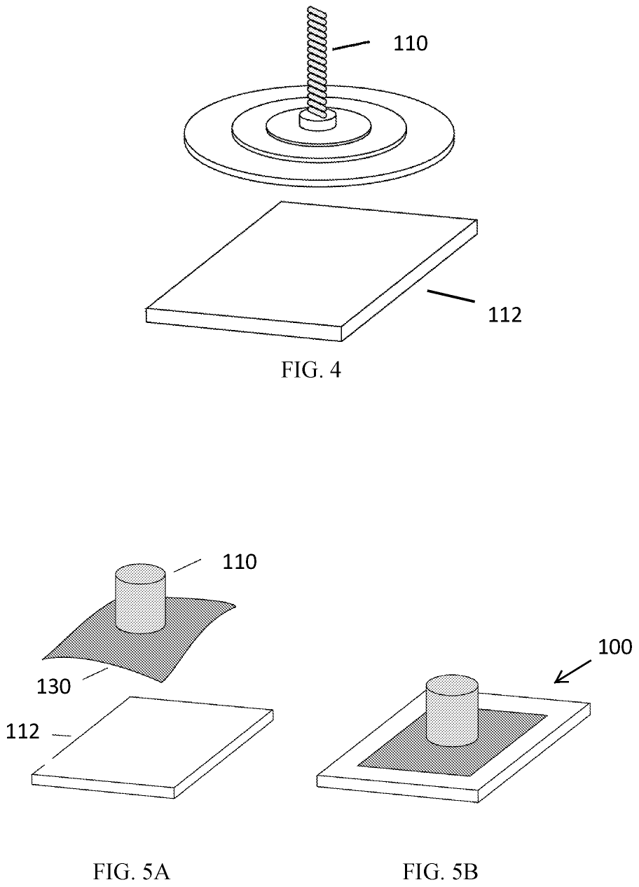

The clutch plates may also take advantage of stiffness variations across the surface of the electrodes 101. One example is shown in FIG. 4, where multiple films are laminated on top of one another to create a stiffness gradient, allowing an optimal combination of surface conformability with the other electrode 101 while distributing load across the electrode surface. Multiple materials may be used as long as the layer at the clutch film interface is conductive to create the necessary electrostatic electrode 101, with at least one of the electrostatic electrodes 101 of the clutch 100 coated with a dielectric material 102 or a dielectric material 102 placed between the electrodes 101. This stiffness gradient could also be achieved with continuously varying material thickness or material properties across the surface, or with a superstructure of rigid or semi-rigid fingers or structure emanating from the rigid connection 110.

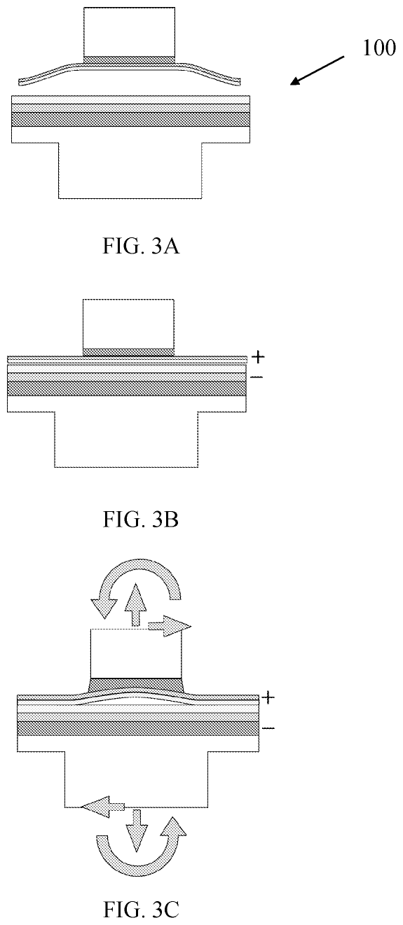

The clutch 100 experiences three states during its use: disengaged, engaged and unloaded, and engaged and loaded as shown in FIGS. 3A-3C. The clutch 100 is disengaged when voltage is not applied and each side of the clutch is free to move relative to one another. The two sides of the clutch 100 may be separated by a large distance and then placed together prior to engaging if it is being used as a connector. In this embodiment, one side of the clutch 100 may be manually placed on the other before activation, or a mechanical or magnetic mechanism 120 can be used to direct one side of the clutch 100 onto the other. In other embodiments, the clutch electrodes 101 may be permanently spaced close together with a small airgap ranging from nominal contact to a few millimeters wide maintained in the disengaged state. When voltage is applied, the attractive force draws the flexible electrode 101 across the gap and establishes an electroadhesive connection allowing force and torque to be transmitted across the interface when loaded. The adhesion and ability to transmit loads will remain indefinitely as long as the applied voltage is maintained and provided the two electrodes 101 do not short, which would equalize the electric charges.

The clutch 100 is susceptible to peel if forces are applied near the perimeter of the flexible side of the clutch and the opposing electrode 101 is rigid, for example. Peeling occurs when an edge of the flexible clutch plate is separated from the rigid clutch plate and the separation propagates across the entire surface from the edge. When forces are applied at the center of the flexible clutch, they are resisted both by electrostatic force between the clutch plates and by the vacuum that forms between the plates if they begin to separate. This embodiment of the clutch can resist complex loading composed of normal forces, shear forces, in-plane torsion, and out-of-plane moments, which distinguishes it from existing electrostatic clutches which are only capable of transmitting in-plane loading, particularly when two rigid clutch plates are used. The vacuum resulting from loading electrodes 101 that have continuous contact allows for a more robust connection with higher force transmission capability and therefore broader uses of the electrostatic clutch 100, but is not necessary for the most basic function of the electrostatic clutch 100.

Table 1 shows the magnitude of normal force that can be transmitted across the clutch interface given several possible dielectric materials 102. The force per unit area is dependent on the thickness of the dielectric insulating layer, the voltage applied, the dielectric constant, breakdown strength, surface resistance of the dielectric insulating layer, and the ability of the overall clutch plate structures to conform and allow good surface contact at the clutch interface. In addition, how much vacuum (pressure difference relative to atmosphere) is developed will depend on how much air is at the interface when the clutch 100 is activated (more air means less pressure difference), how well adhered the flexible electrode 101 is to the second electrode 101 or surface, how rough the electrodes 101 are, and whether there are pathways for air to travel to the clutch interface from atmosphere. The force/voltage hysteresis refers to undesirable residual adhesion and voltage that remains even after the voltage is removed, and can subsequently reduce responsiveness or holding force on subsequent charge and discharge cycles.

TABLE 1

| | | Dielectric | Electrostatic | Vacuum | Total | | |
|---|---|---|---|---|---|---|---|
| | | layer | Force per | Force per | normal | Operating | Force/ |
| | Dielectric | thickness | unit area | unit area | force per | voltage | Voltage |
| | material | (um) | (N/cm\hat{ }2) | (N/cm\hat{ }2) | unit area | (V) | Hysteresis |
| Commonly | Polyimide, | 5-50 | 0.2-5.6 | 0-10 | 10.2-15.6 | 500-2000 | High |
| used | polyethylene, | | | | | | |
| polymer | PVDF | | | | | | |
| dielectric | | | | | | | |
| materials | | | | | | | |
| Prior art | DUPONT | 20-100 | 2.9-5.7 | 0-10 | 12.9-15.7 | 250-350 | Low |
| dielectric | Luxprint | | | | | | |
| layers | 8153 | | | | | | |
| (years | ceramic | | | | | | |
| 2014- | particle- | | | | | | |
| 2021) | embedded | | | | | | |
| | polymer | | | | | | |
| | Aluminum | 3-50 | 11-85 | 0-10 | 21-95 | 12-300 | Very |
| | Oxide | | | | | | Low |
| | Titanium | 1-10 | 2.9-280 | 0-10 | 12.9-290 | 5-200 | Very |
| | Dioxide | | | | | | Low |

The clutches 100 described here may be used as typical clutches, connectors, brakes, dampers, force limiters, torque limiters or mechanical fuses. Multiple uses of each clutch 100 are enabled by strategic control of the applied voltage. High voltages will enable the clutches 100 to produce large forces or torques to resist motion or lock the relative position of components. Medium voltages will supply lesser forces or torques which may be overcome by the user or driving actuator. In this case, the clutches 100 described here act as mechanical fuses that release when applied forces exceed the allowable load. The figures show various clutches 100 utilizing the solid ceramic-based dielectric layer 102.

FIGS. 5A-5B depict a configuration of the clutch 100 that utilizes: FIG. 5A—a flat and smooth conductive element (i.e. electrode 101) as as a rigid clutch half, and a a flexible membrane with a conductive element (i.e. electrode 101) as the flexible clutch half. A rigid element 110 is attached to the flexible clutch half and can be used to transmit a load through the flexible clutch half. FIG. 5B shows that the flexible membrane conforms to the flat surface of the rigid side of the clutch 100 when engaged.

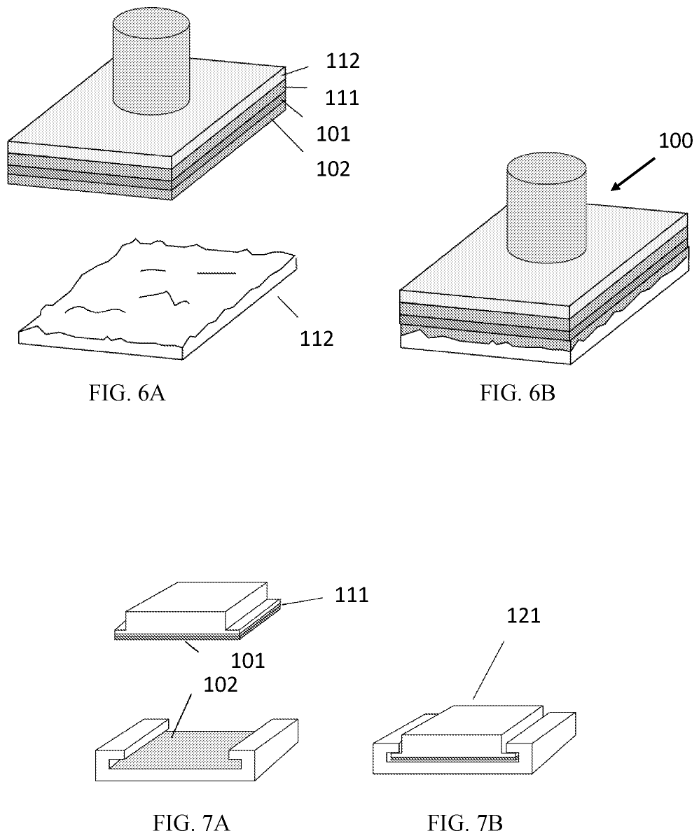

FIGS. 6A-6B depict a clutch 100 that accommodates a rigid clutch half with a rough or irregular surface as shown in FIG. 6A. In this embodiment, one clutch half is comprised of a flat semi-flexible or rigid portion with a low-stiffness gap-filling material 111 that allows the flexible electrode 101 to conform to the irregular surface of the rigid side of the clutch 100 as demonstrated in FIG. 6B. The semi-flexible portion is connected to a rigid element 110 for transmitting load from the clutch 100 to a handle or other component. In this embodiment, the rigid backing 112 has a conductive surface and is acting as a second electrode 101 opposite the flexible electrode 101.

FIGS. 7A-7B show a connector 121 that utilizes rails or slots to resist peel in addition to electrostatic and vacuum forces. FIG. 7A shows a clutch half as a rigid surface with peel resisting rails 121. The face of the clutch interface is coated with a dielectric material 102. The other clutch halfhas a rigid backing 112 to engage the slots 121 on the other electrode 101 and is shown with an optional gap-filling material 111 topped with a flexible electrode 101. The clutch halves slide together as shown in FIG. 7B. Ease of sliding the clutch components together may be improved by the addition of a chamfer, or sloped guide.

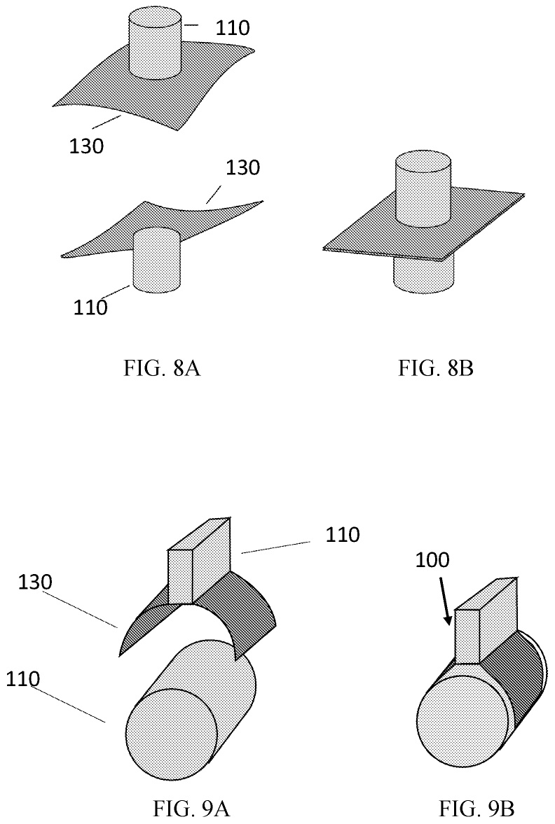

FIGS. 8A-8B show an embodiment in which both sides of the clutch 100 include a flexible element 130 on which is disposed a rigid structure 110 for transmitting loads. FIG. 8A demonstrates both halves are flexible. FIG. 8B demonstrates that the flexible portions conform to one-another when voltage is applied in the engaged state. Here, the flexible element 130 comprises an electrode 101 and potentially a dielectric material 102.

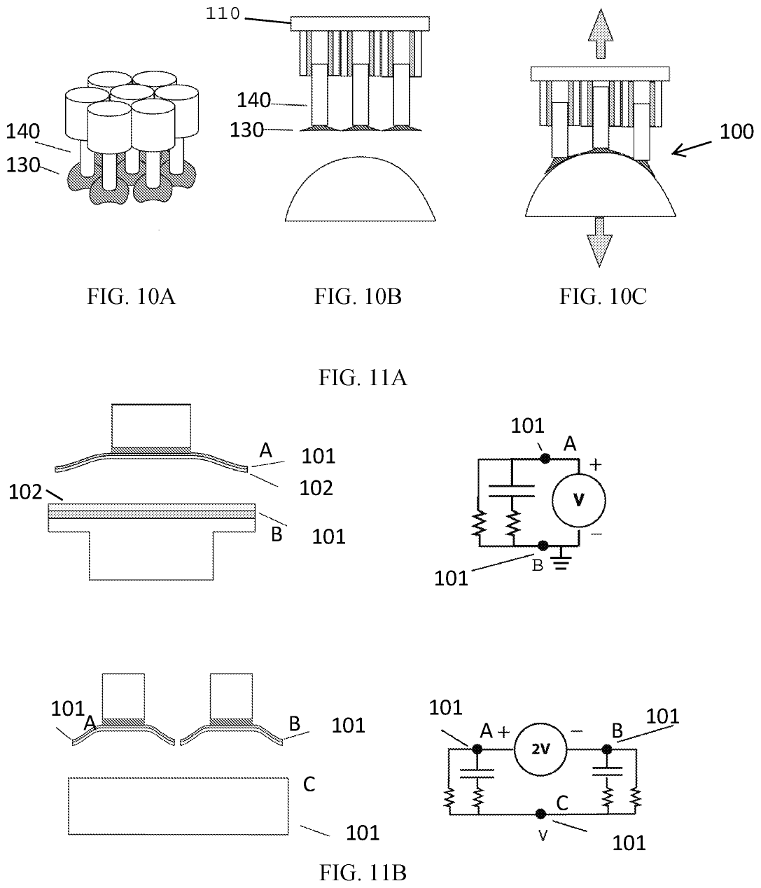

FIGS. 9A-9B depict an embodiment in which the rigid structure 110 attached to the flexible clutch electrode 101 is long and thin, thus allowing the electrode 101 “fingers” to drape over round or cylindrical structures. This configuration may be applied to a gripper-style clutch 100 with more than two flexible “fingers” to grasp objects with more complex geometry.

FIGS. 10A-10C show a clutch 100 that can be used to pick and place objects with curved or otherwise irregular surfaces. As shown in FIG. 10A, the gripper-style clutch 100 is comprised of several flexible clutch surfaces mounted on flexible or telescoping fingers 140. The flexible ends of the fingers 140 conform to flat surfaces and adhere when voltage is applied as shown in FIG. 10B. FIG. 10C demonstrates that the gripper-style clutch 100 can grasp objects with curved or irregular surfaces as each telescoping element or flexible finger 140 can contract to different lengths to accommodate changes in elevation on the surface of the object. The flexible nature of the clutch electrodes 101 on each of the fingers 140 allows each finger some ability to conform to an irregular surface as well. The telescoping fingers 140 may also have individual clutches 100 to lock the telescoping length once the electrodes 101 are adhered when voltage is activated. Control could be simple, with the individual clutches 100 locking or releasing the telescoping fingers simultaneously with the gripper activation and deactivation. A controller 103 for this type of configuration where two clutch plates are not directly touching will be discussed in greater detail below.

All embodiments of the clutch 100 design can utilize a number of different electrical configurations or controllers 103 including but not limited to the configurations shown in FIGS. 11A and 11B.

FIGS. 11A and 11B demonstrate two electrical configurations that enable different clutch behaviors. FIG. 11A shows a configuration in which both sides of the clutch 100 are permanently connected to an electrical circuit. In this configuration the clutch halves are placed in contact with one-another and voltage is applied across them. The dielectric coating 102 disposed between the electrodes 101 creates a capacitor. This capacitor prevents charges from equalizing across the two clutch halves and enables the electroadhesive attraction. Low voltage is applied to one clutch half and high voltage is applied to the other; for the majority of electrode 101 and dielectric materials 102 performance is similar regardless of which side of the clutch 100 receives low or high voltage. FIG. 11A shows the electrical diagram of this configuration where the clutch interface is modeled as a capacitor with parallel and series resistors, which accounts for the capacitance of the dielectric material 102, the effective resistance of the clutch interface, and electrical connector resistance.

FIG. 11B shows a different electrical configuration which enables more general object manipulation. In this embodiment there are two flexible electrodes 101 used as an electroadhesive manipulator. High voltage is applied to one flexible electrode 101 and low voltage is applied to the other electrode 101. Both electrodes 101 contact an object with a conductive surface. In this configuration no explicit electrical connection is made to the conductive surface of the object, which acts as the second clutch half. If the effective electrical resistance of both clutch interfaces with the object is equal, the relative voltage of the rigid object becomes half of the total voltage applied across the manipulator's electrodes 101. The voltage difference between the flexible electrodes 101 and the manipulated object enables electroadhesion. This configuration enables the clutch-based manipulator to apply complex mechanical loading to objects that are not connected to a common electrical circuit with the manipulator-style clutch 100. This configuration may include two or more physically separate flexible clutch electrodes 101 that simultaneously interact with the object. These physically-separate, but electrically-connected electrodes 101, may exist on two separate structures, such as a paddle for each hand of the operator, or be mounted on a single greater structure. This improvement is analogous in some ways to the difference between a brushed DC motor and a brushless DC motor, in that the brushless DC motor reconfigures the motor components to eliminate the need for an explicit electrical connection from components on the rotor to the terminals of the voltage supply.

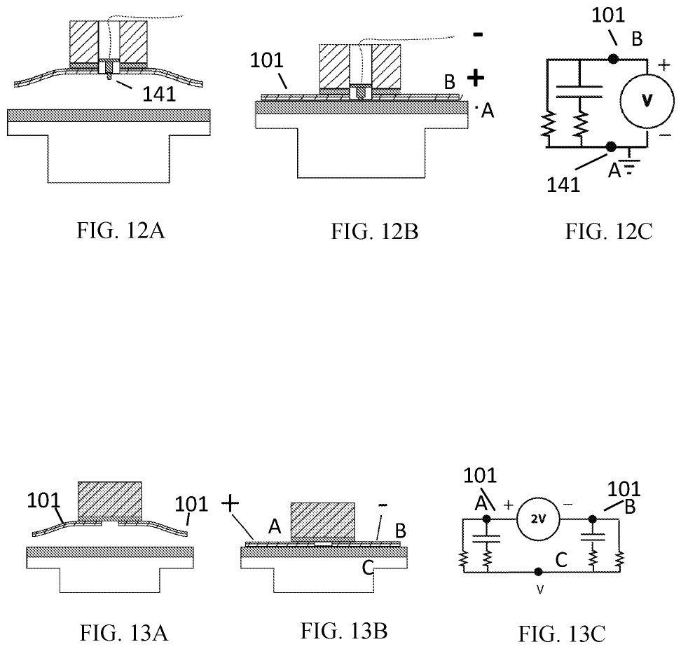

These same two electrical configurations can be achieved with different variations of clutch design. FIGS. 12A-12C depict an embodiment of an electroadhesive manipulator-style clutch 100 in which an explicit but temporary electrical connection to the manipulated object is achieved by a probe 141. This probe 141 may be a pogo pin as shown, a spring contact, a magnet assisted contact, or other electrical probe. FIGS. 13A-13C depict an embodiment in which two or more electrodes 101 are electrically separated by a dielectric 102 or air gap, but mechanically connected as parts of a single continuous component. This design can be represented by the electrical diagram shown in FIG. 11B. The difference between the embodiments shown in FIG. 11B and FIGS. 13A-13C is that the two electrodes 101 can be separated on two different gripping elements or contained within a single gripping element. In either case, the number of electrically separate electrodes 101 can be two or any multitude.

When a split paddle is used, it is beneficial for the same area of each electrode 101 to be engaged, which ensures near equal capacitance in each of the clutch interfaces. This ensures that the manipulated object is held at a voltage potential near to one half that of the applied voltage when two electrodes 101 are utilized. FIG. 14 shows a number of possible electrode configurations that can enable engaged areas of near equal sizes on both electrodes 101. Engaging the same electrode area is most simply accomplished by splitting the surface in half if the object being manipulated is easily centered on the gripping surface, is the same size as the gripping surface, or is larger than the gripping surface. However, when the object being manipulated is smaller than the gripping surface of the clutch 100, it can be beneficial to pattern the two electrodes 101 such that any object of sufficient size is equally or nearly equally covered by each electrode 101. Patterns may include combs, spirals, or continuous pie slices. These patterns are easily achieved with a single layer structure as the electrode areas are continuous. Concentric rings, checkers, stripes, dots, and other patterns that ensure nearly equal coverage can be achieved by multi-layer structures in which the electrodes 101 are kept electrically isolated by dielectric materials 102. These multi-layer structures can be composed of multi-layer printed circuits.

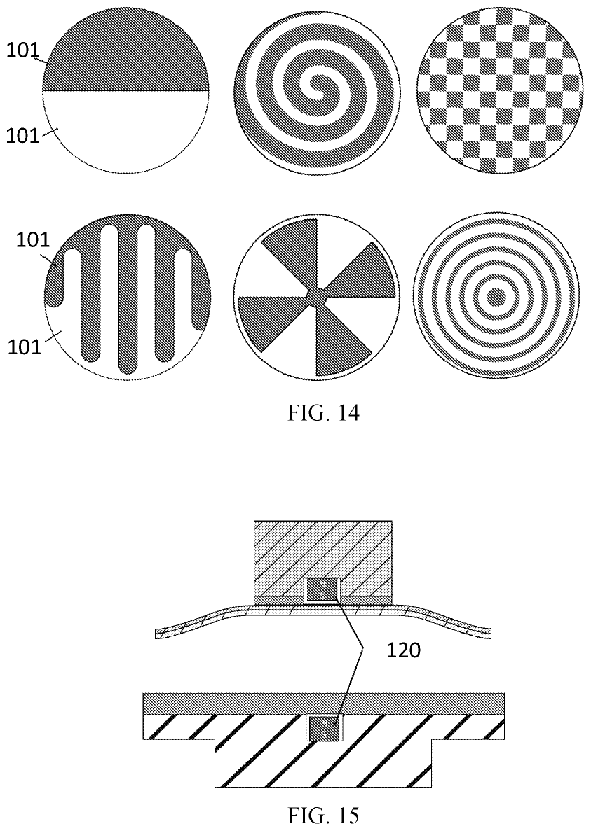

Quick and repeatable alignment between two halves of a universal electroadhesive clutch 100 can be achieved by incorporating magnets into the structure as an alignment mechanism 120. FIG. 15 shows such an embodiment. The alignment mechanism 120 may include two permanent magnets oriented such that they attract one another or a single magnet and a ferrous material within a non-ferrous structure. The magnet may be permanent or electrically activated. Quick and repeatable alignment of the clutch halves can also be assisted by recessing one of the electrodes 101. Clutches 100 in which one clutch half electrode surface is larger than the other may make the clutch more tolerant of misalignment.

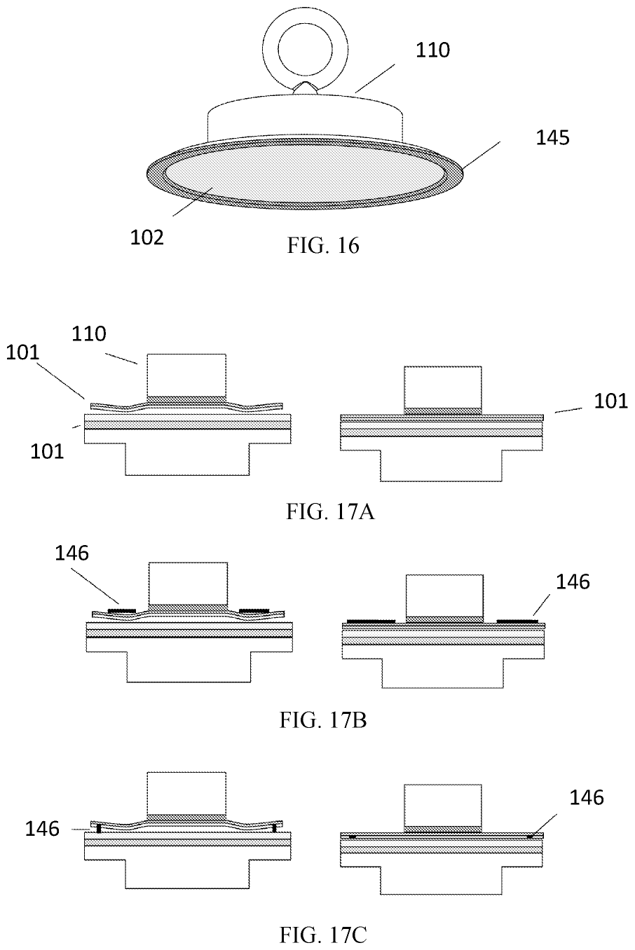

In many embodiments the clutch electrode 101 is coated with a dielectric material 102. This material 102 may be deposited onto the electrode material in sheets or rolls before the electrode 101 is cut into its final shape. When this process is used, the cut edges of the electrode 101 remain conductive despite the surface being coated with a dielectric 102. This can create opportunities for shorting and can be resolved by insulating the cut edge as shown in FIG. 16. The insulation 145 disposed over the cut edges may be applied in a number of ways including but not limited to: gluing, laminating, mechanical fastening, dipping, spraying, or painting. Any insulating material may be used. If the insulating material 145 is conformable such as rubber or silicone it may be used to enhance the suction effect experienced by the clutch 100.

When the voltage is removed, the electrostatic attraction between the electrodes 101 dissipates and the clutch 100 disengages. Some force may temporarily remain between the electrodes 101 because of Van Der Waals attraction or remaining suction. The force required to separate the disengaged clutch 100 can be reduced to near zero by utilizing a low-stiffness flexible electrode 101 that is formed or prestressed to have raised or curved edges along its perimeter as shown in FIG. 17A. The prestressed or curved design requires only small forces to flatten curved edges to conform to the opposite electrode 101, and these forces can be provided by the attractive electrostatic-zipping forces when a voltage is applied. FIG. 17B shows the curved edges drawn down to contact the opposing clutch half by electrostatic forces. When voltage is removed, internal stresses in the flexible electrode 101 will cause the edges to peel and relieve the vacuum as the curved edges return to their original shape. This effect may also be achieved by adding additional low stiffness structures 146 such as elastic bands or small beam springs. Piezo-electric material may also be disposed on the electrode surface facing away from the clutch interface to act as a bending mechanism 146. This material should be disposed such that the direction of its length change is perpendicular to the electrode edges. This ensures that when the piezo-electric material is shortening by modulating applied voltage, the result will be curling the edges away from the clutch interface to aid release.

In another embodiment shown in FIG. 17C, piezoelectric pillars, used as bending mechanism 146, may be disposed near the perimeter of the clutch interface such that when they are elongated they act to separate the clutch electrodes 101. This relieves vacuum forces and increases the air gap between the electrodes 101 which can reduce the force required to disengaged the clutch 100 when voltage is removed.

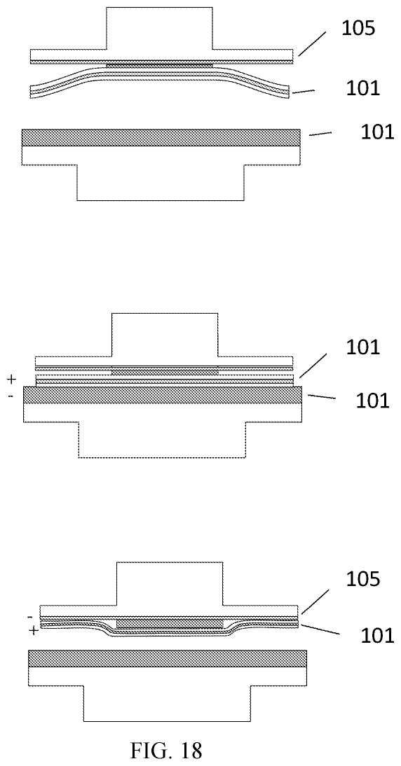

FIG. 18 depicts another embodiment in which a secondary electrode 105 is used to retract a flexible electrode 101 away from the primary clutch interface during release. The flexible electrode 101 adheres to to the opposite clutch electrode 101 when voltage is applied across the clutch interface. To disengage, the voltage difference across the clutch interface is removed and a voltage difference is applied between the flexible electrode 101 and the secondary electrode 105 located on the opposite side of the flexible electrode 101.

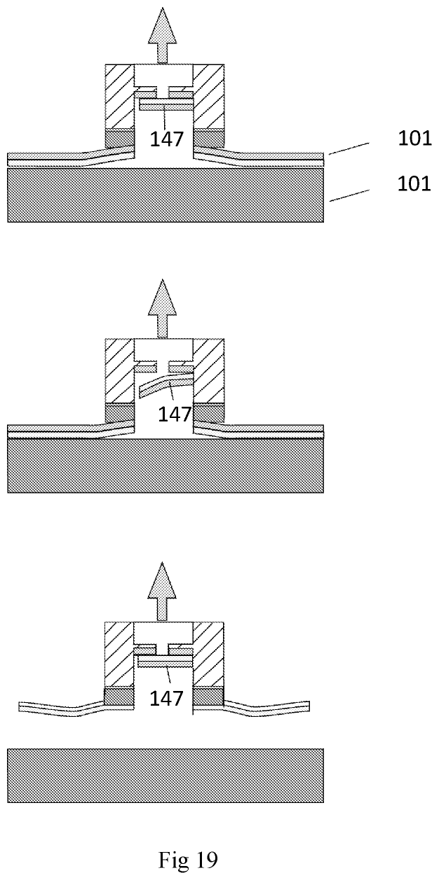

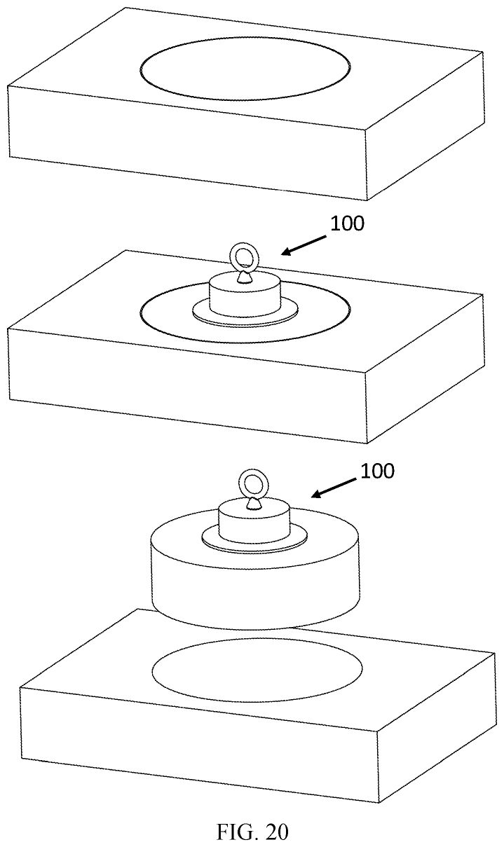

FIG. 19 depicts an embodiment in which a flexible electrode 101 is used as a controllable check valve 147. Air is prevented from entering the space between the two electrodes 101 when the electroadhesive check valve 147 is engaged. This allows a vacuum to form. Air is free to move into the space between the clutch electrodes 101 when the electroadhesive check valve 147 is released. This relieves any vacuum present at the clutch interface. This configuration can result in lower forces required to disconnect the two electrodes 101 in the disengaged state.

Universal clutches 100 may be used to prevent unwanted tamporing or access by creating a removable handle. FIG. 20 depicts a device in which a recessed lid has no grippable surfaces and fits snuggly in a recess. An electroadhesive clutch 100 is used as a temporary handle to remove the lid. Similarly, electroadhesive clutches 100 can act as temporary handles for moving heavy or large and awkward to grasp objects. This has added benefits if the lack of permanent handles or grasping locations provides anti-theft or anti-tampering effects.

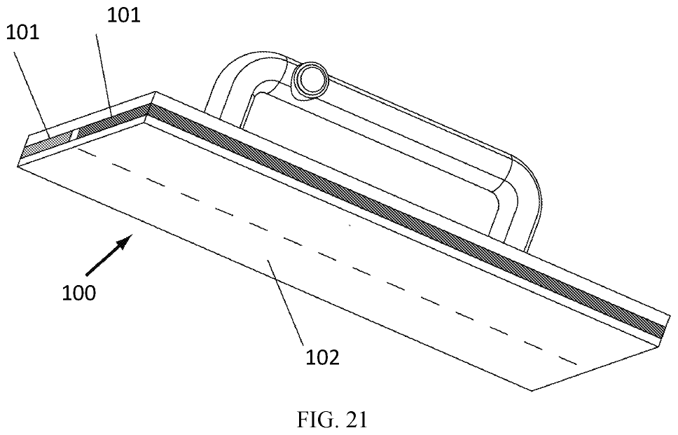

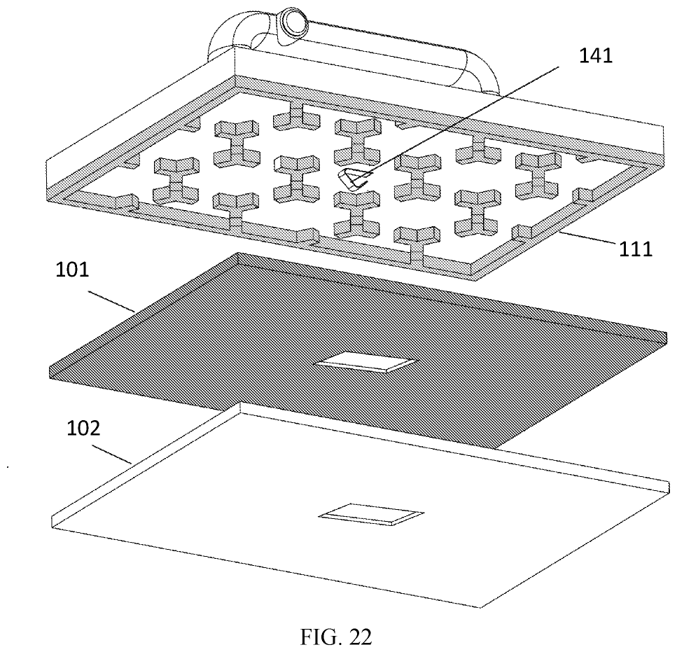

Electroadhesive surface clutches 100 can be used to handle delicate materials. FIG. 21 depicts a surface clutch 100 with a split electrode 101 for manipulating foil or other thin delicate conductive materials without making an explicit electrical connection to the manipulated materials. In this embodiment conformability of the clutch 100 is provided by the manipulated material such as foil or conductive fabrics. FIG. 22 depicts a variation on the delicate material handler-type clutch 100 that can accommodate heavier and/or more more irregular materials by incorporating increased flexibility. This flexibility is enabled via selective patterning of compliant adhesive to secure the electrode 101 to the the larger structure of the clutch 100. The pattern shown here creates hexagonal pockets that can allow the flexible electrode 101 to flex towards or away from the clutch interface. A dielectric material 102 is disposed over the electrode 101. This material handler-type clutch 100 can be used with either electrical configuration shown in FIGS. 12A-12C and FIGS. 13A-13C. FIG. 22 shows an embodiment in which an electrical connection is established to the manipulated material via a spring contact 141 that contacts the surface of the film through an aperture in the electrode 101 and dielectric 102. This electrical contact could also be established to the side of the electrode surface without the use of an aperture. Alternatively, the electrode 101 could be of the split variety thus not requiring an explicit electrical connection to the manipulated material.

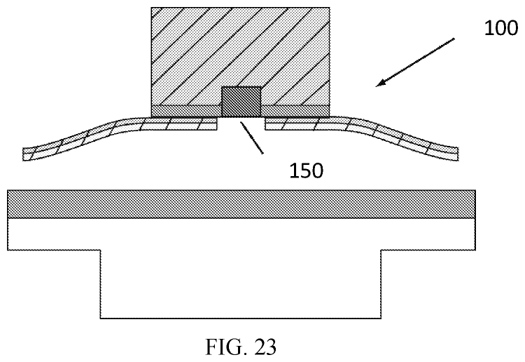

FIG. 23 shows an embodiment in which a sensor 150 can be included to aid in the timing of engagement. This sensor 150 may be a proximity sensor, photoresistor, pogo-pin, contact switch, or other sensor. Alternatively, the electrode 101 itself can be used as a capacitative touch or distance sensor. Sampling the capacitance of the clutch interface continuously or intermittently can provide a signal for engaging the clutch 100 when contact is made with an appropriate material. The capacitance of the clutch interface can also provide insight into the amount of overlap area between the electrodes and the alignment of the electrodes.

In embodiments of the clutch 100 the dielectric material 102 may be applied to one or both halves of the clutch or placed in a manner to separate opposing electrodes 101 and the flexible electrode 101 may be comprised of metalized polymer sheets, carbon fiber, carbon or metal infused polymer, or any other flexible and conductive material. Additionally, other embodiments of the clutch 100 may utilize either of the electrical configurations previously described.

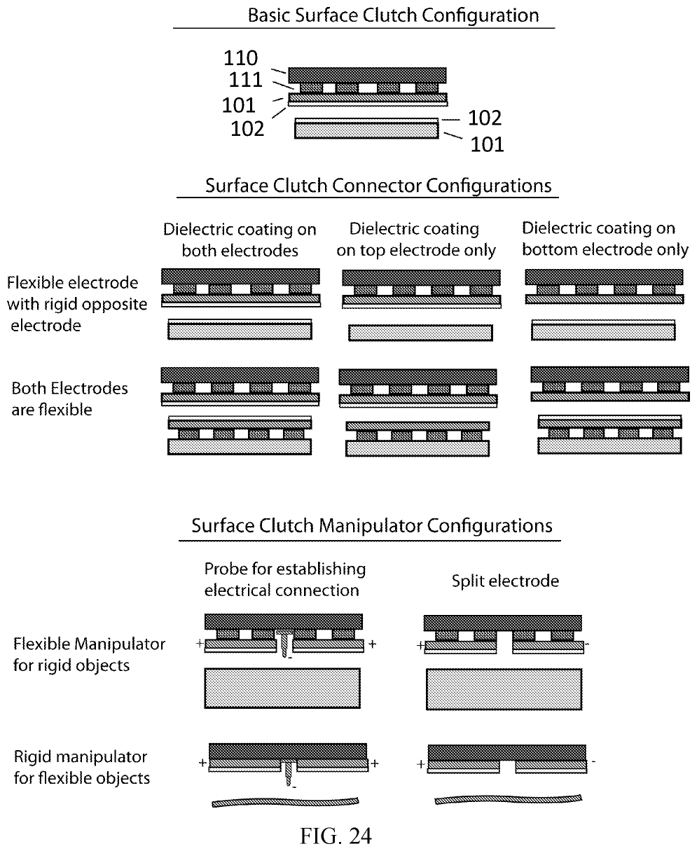

FIG. 24 presents a non-inclusive summary of many of the combinations available regarding flexibility, disposition of dielectric 102 and electrical configuration. One or all electrodes 101 may be flexible or conformable. One or all electrodes 101 may have a dielectric coating. All electrodes 101 may include explicit electrical connections to the circuit or controller 103 as would be the case for many applications in which the clutch 100 is being used as a connector. This electrical connection may be permanent, or temporarily established through an electrical probe 141 such as a spring contact or pogo pin. The universal clutch 100 may also be used as a manipulator for generic conductive materials without establishing an explicit electrical connection by using the split electrode configuration. When used as a manipulator, some flexibility either in the clutch electrode 101 or in the manipulated material itself enables operation at low voltages and accommodation of more irregular surfaces than would normally be tolerated.

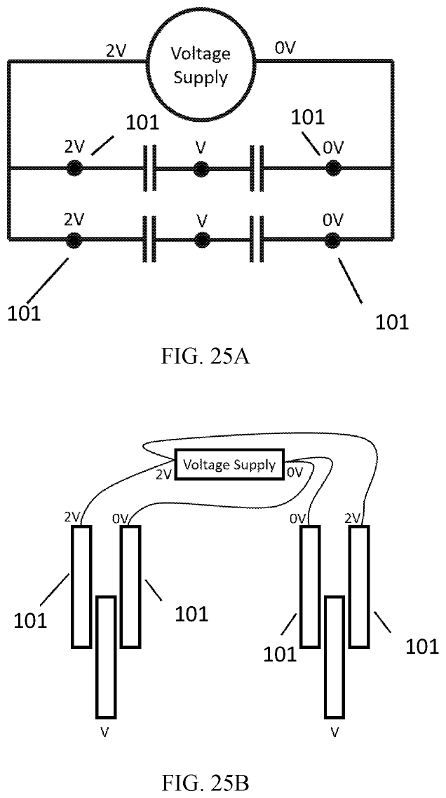

FIG. 25 illustrates an embodiment of the three or more electrode 101 electroadhesive clutch electrical configuration that enables some electrodes 101 to operate without direct electrical connectors that attach them to the terminals of the power supply. The electrical equivalent diagram is shown in FIG. 25A while leaving out the series and parallel resistances that are present with real-world capacitors, and simply representing the capacitance of the clutch interfaces. In this configuration, two sets of clutch plates operate in parallel using the same voltage supply. In other configurations, many sets could similarly operate in parallel. The high-side electrode of each set is directly connected to the positive terminal of the voltage supply in the controller 103 and has a resulting voltage of 2V. The low-side electrode of each set is connected to the negative terminal of the voltage supply and has a resulting voltage of 0V. The electrode 101 is adjacent to the second and third electrodes 101 and completes the circuit, existing at an intermediate voltage of V. This accomplishes a voltage difference equal to 1V across each of the clutch interfaces and results in adhesion and locking at each clutch interface. FIG. 25B shows a physical schematic of the electrodes 101. While two of the electrodes 101 are physically connected to the voltage supply with electrical connections, each of the other electrodes 101 are free to translate or rotate indefinitely relative to the voltage supply without the need for flexible, extensible, or brushed electrical connections.

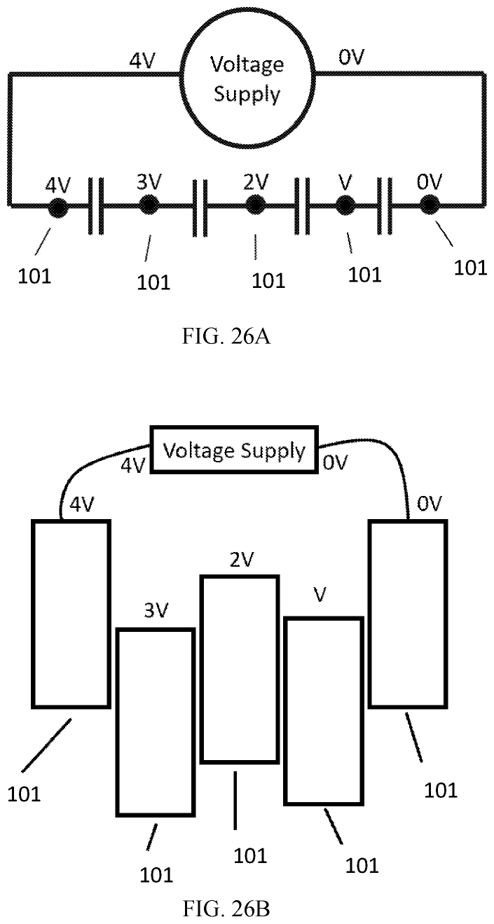

FIGS. 26A-26B illustrates another embodiment of the three or more electrode electroadhesive clutch electrical configuration that enables some electrodes 101 to operate without direct electrical connectors that attach them to the terminals of the power supply in the controller 103. The electrical equivalent diagram is shown in FIG. 26A while leaving out the series and parallel resistances that are present with real-world capacitors, and simply representing the capacitance of the clutch interfaces. This embodiment creates a circuit equivalent to four capacitors in series with one another. Assuming the effective resistance of each clutch interface is the same, this results in a voltage difference of approximately IV across each clutch interface. FIG. 26B shows a physical schematic of the electrodes 101. While the first set of electrodes 101 are physically connected to the voltage supply with electrical connections, each of the second set of electrodes 101 are free to translate or rotate indefinitely relative to the voltage supply without the need for flexible, extensible, or brushed electrical connections.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. In particular, one or more features in any of the embodiments described herein may be combined with one or more features from any other embodiments described herein.

Protection may also be sought for any features disclosed in any one or more published documents referred to and/or incorporated by reference in combination with the present disclosure.

1. An electroadhesive clutch for transmitting a normal, shear, or torsional load, comprising:
a first electrode having an electrically conductive surface,
wherein at least a portion of a surface of the electrode is flexible,
wherein at least a portion near the perimeter is unattached to a structural element;
a second electrode having an electrically conductive surface;
a dielectric material separating the electrically conductive surface of the first electrode from the electrically conductive surface of the second electrode; and
a controller that applies a voltage difference to the first electrode and the second electrode.

2. The electroadhesive clutch of claim 1, further comprising: a rigid element attached to the first electrode, wherein the rigid element is capable of transmitting a force in a direction substantially perpendicular to the conductive surface of the first electrode.

3. (canceled)

4. (canceled)

5. The electroadhesive clutch of claim 2, wherein a portion of the first electrode near a perimeter of the first electrode has a lower bending stiffness than a middle portion of the first electrode.

6. (canceled)

7. The electroadhesive clutch of claim 1, wherein the first electrode is attached to a first object and the second electrode is attached to a second object, allowing the first object to mechanically couple to the second object to transmit torque, shear force, or normal force.

8. (canceled)

9. The electroadhesive clutch of claim 1, further comprising: a first connector associated with the first electrode; and a second connector associated with the second electrode, wherein the first connector and the second connector are adapted to mechanically engage to prevent delamination of a perimeter of the first electrode.

10. (canceled)

11. The electroadhesive clutch of claim 1, wherein the second electrode has a shape selected from the group consisting of cylinder, cube, prism, sphere, and non-flat, wherein the first electrode conforms to the shape of the second electrode.

12. (canceled)

13. The electroadhesive clutch of claim 1, further comprising:
a telescoping finger attached to each of the first electrode, the second electrode, and the at least one additional electrode, wherein the first electrode, the second electrode, and the at least one additional electrode are selectively connected to the substrate via the telescoping finger using an electroadhesive clutch that allows relative displacement between the first electrode, the second electrode, the at least one additional electrode, and the substrate when in the deactivated state.

14. The electroadhesive clutch of claim 1, wherein the first electrode and the second electrode are disposed on a clutch plate in a side-by-side, spiral, checkerboard, interconnecting fingers, concentric circle, or interleaved pattern.

15. The electroadhesive clutch of claim 14, wherein an area of the first electrode is substantially equal to an area of the second electrode.

16. (canceled)

17. The electroadhesive clutch of claim 1, further comprising:
a sensor associated with the first electrode or the second electrode, wherein the sensor detects distance, proximity, perpendicular alignment, or parallel alignment of a first clutch plate relative to second clutch plate.

18. (canceled)

19. The electroadhesive clutch of claim 1, wherein the first electrode is non-planar in a disengaged state and deforms in an engaged state, permitting the first electrode to release from the second electrode when transitioning from the engaged state to the disengaged state.

20. The electroadhesive clutch of claim 1, further comprising: a release mechanism, wherein the release mechanism comprises an additional electrode that attracts the first electrode when transitioning from an engaged state to a disengaged state to initiate a release of the first electrode from the second electrode.

21. The electroadhesive clutch of claim 1, further comprising: a check valve associated with the first electrode to release a vacuum formed in an engaged state.

22. The electroadhesive clutch of claim 1, wherein the first electrode fits into a recess of the second electrode.

23. (canceled)

24. The electroadhesive clutch of claim 1, wherein the first electrode further comprises a cut-out to allow routing of a contact-based electrical connection to the second electrode using a spring loaded pin, soft or flexible electrical brush, or similar electrical connector.

25. The electroadhesive clutch of claim 24, wherein the first electrode is attached to a rigid connector capable of transmitting a load substantially perpendicular to the electrically conductive surface of the first electrode.

26. The electroadhesive clutch of claim 1, further comprising: an alignment mechanism comprising a first magnet associated with the first electrode and a second magnet associated with the second electrode, wherein the first magnet and the second magnet provide an attractive or repulsive force that encourages in-plane or out-of-plane alignment of the first electrode and the second electrode.

27. (canceled)

28. (canceled)

29. (canceled)

30. (canceled)

31. The electroadhesive clutch of claim 1, further comprising: at least one additional electrode having an electrically conductive surface, wherein the first electrode, the second electrode, and the at least one additional electrode are electrically isolated from each other, wherein the dielectric material separates the dielectric surface of the first electrode, the second electrode, and the at least one additional electrode; and a controllable voltage source connected to at least one of the first electrode, the second electrode, and the at least one additional electrode.

32. The electroadhesive clutch of claim 31, wherein at least one of the first electrode, the second electrode, and the at least one additional electrode does not have a direct electrical connection to the voltage source.

33. (canceled)

34. (canceled)

35. The electroadhesive clutch of claim 31, wherein only two electrodes have a direct electrical connection to the voltage source.

36. (canceled)

37. The electroadhesive clutch of claim 31, wherein the first electrode, the second electrode, and the at least one additional electrode are arranged in multiple sets connected in parallel to a single power supply.

38. The electroadhesive clutch of claim 32, wherein the electrode without a direct electrical connection to the voltage source translates or rotates relative to the voltage source.

39. (canceled)

40. The electroadhesive clutch of claim 1, wherein the first electrode is adapted to allow routing of a contact-based electrical connection to the second electrode using a spring loaded pin, soft or flexible electrical brush, or similar electrical connector.
